(19) United States
(12) Patent Application Publication
(10) Pub. No.: US 2001/0053506 A1
(43) Pub. Date: Dec. 20, 2001

(54) Wick stand

(76) Inventor: Sang-Choul Moon, Seoul (KR)

Correspondence Address: Finnegan, Henderson, Farabow, Garrett & Dunner, L.L.P., 1300 I Street, N.W., Washington, DC, 20005-3315, US

(21) Appl. No.: 09/862,595

(22) Filed: May 23, 2001

(30) Foreign Application Priority Data
May 25, 2000 (KR) 2000 28419

(51) Int. Cl. F23D 3/16; F21V 35/00

(52) U.S. Cl. 431/292; 431/289

(57) ABSTRACT

The present invention relates to an oil lamp, and more particularly, to a wick stand by which a lamp can be constructed by using a container available everywhere in the surroundings, without preparing a particular container for fixing a wick in a conventional oil lamp. The wick stand disposed in the container with paraffin oil accommodated therein comprises a wick fixing portion 10 having a hanging projection 11 at one side thereof and with a wick 1 inserted thereinto and fixed thereto; and a body 20 having an inserting bore 21, into which the wick fixing portion 10 can be inserted, at an upper end thereof which the hanging projection 11 hangs on and is fixed to, and inlet holes 22 for causing the paraffin oil to flow into a lower inner portion of the body. Therefore, since the present invention can use a saucer in the form of dish or a container for accommodating oil, such as an aesthetic cup or teacup available everywhere in the surroundings, without requiring an exclusive container for fixing the wick in the conventional oil lamp, there is an advantage that it is convenient to use it.

### FIELD OF THE INVENTION

The present invention relates to an oil lamp, and more particularly, to a wick stand by which a lamp can be constructed by using a container for accommodating oil, such as an aesthetic cup or teacup available everywhere in the surroundings, without preparing an exclusive container for fixing a wick in a conventional oil lamp.

### BACKGROUND OF INVENTION

The conventional lamp comprises a container 2 for accommodating liquid fuel such as paraffin oil, and a wick fixing portion 3 which is inserted into and fixed to an opening portion of the container, whereby a wick 1 is inserted into and fixed to the wick fixing portion 3, as shown in FIG. 1.

The conventional lamp constructed as such must include the particular container having the opening portion in the shape capable of fixing the wick fixing portion 3 with the wick 1 inserted thereinto. In addition, in case of replenishing the container with the paraffin oil, there is inconvenience in that the container should be replenished with the paraffin oil only after the wick fixing portion 3 has been removed from the container 2. Furthermore, since glass is generally used as material for the container so as to secure an aesthetic sense, a user may be injured by breakage of the container due to the user's carelessness when replenishing the container with the paraffin oil.

### SUMMARY OF INVENTION

The present invention is conceived to solve the above problems. It is an object of the present invention to provide a wick stand by which a lamp can be constructed by using a container for accommodating oil, such as an aesthetic cup or teacup available everywhere in the surroundings, other than a particular container for fixing a wick in the prior art.

The above object of the present invention can be achieved by a wick stand disposed in a container with paraffin oil accommodated therein, comprising a wick fixing portion having a hanging projection at one side thereof and with a wick inserted thereinto and fixed thereto; and a body having an inserting bore, into which the wick fixing portion can be inserted, at an upper end thereof which the hanging projection hangs on and is fixed to, and inlet holes for causing the paraffin oil to flow into a lower inner portion of the body.

### BRIEF DESCRIPTION OF THE DRAWINGS

FIG. 1 is a perspective view showing a conventional paraffin oil lamp.

FIGS. 2a and 2b are perspective views showing a first embodiment of a wick stand of the present invention.

FIG. 3a is an exploded perspective view of the wick stand shown in FIG. 2a.

FIG. 3b is a sectional view taken along line A-A′ of FIG. 3a.

FIG. 4a is a perspective view showing a second embodiment of the wick stand of the present invention.

FIG. 4b is a sectional view taken along line B-B′ of FIG. 4a.

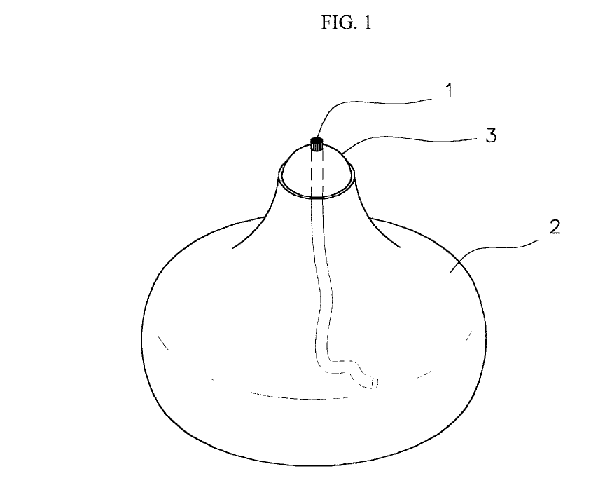

### DETAILED DESCRIPTION FOR PREFERRED EMBODIMENT

Hereinafter, preferred embodiments of the present invention will be explained in detail with reference to the accompanying drawings.

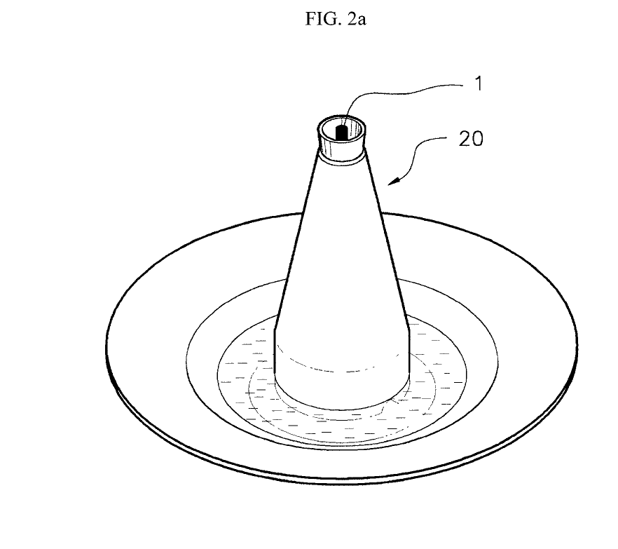

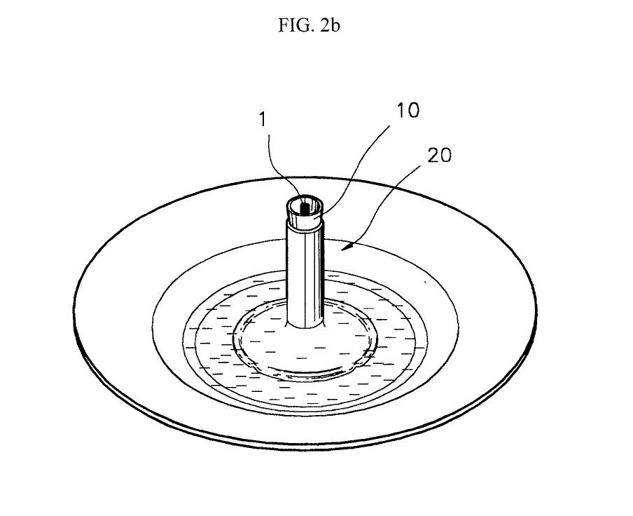

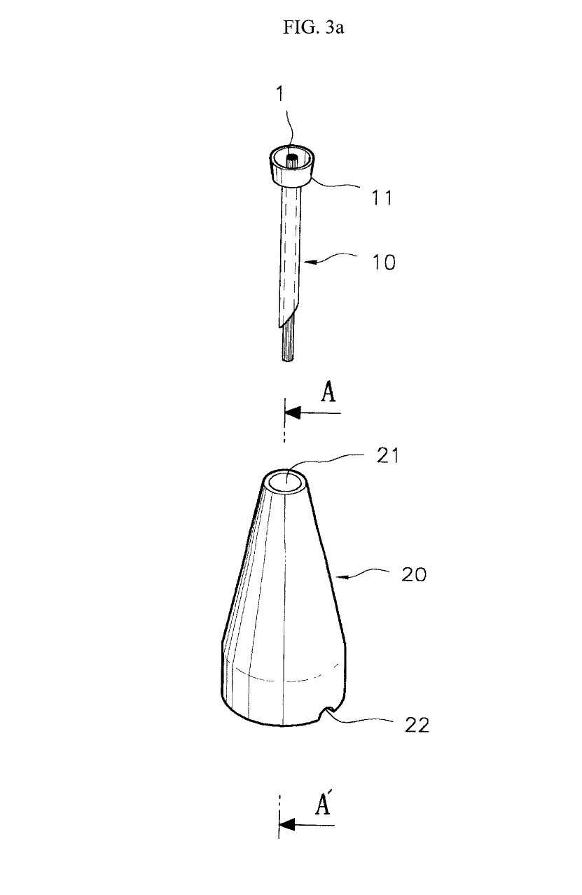

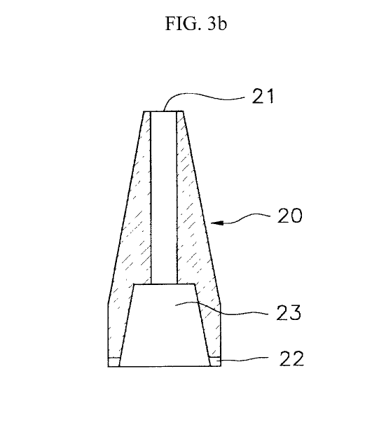

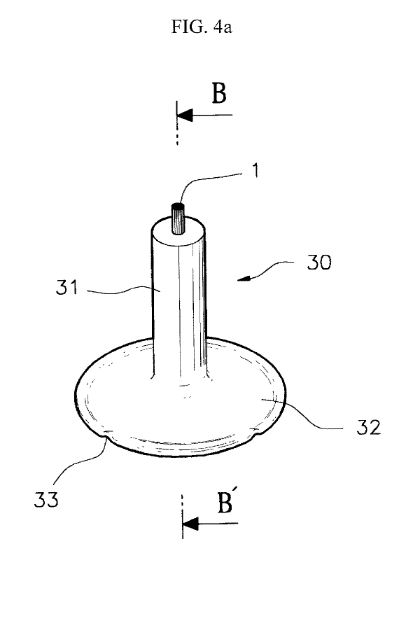

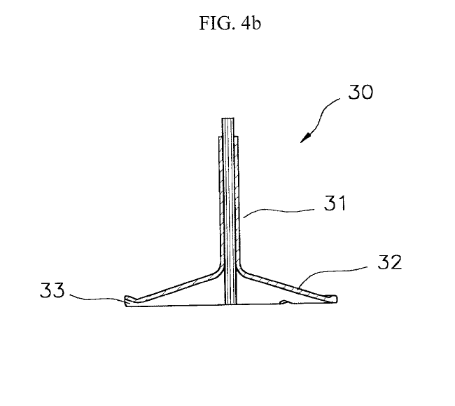

FIGS. 2a to 4b are views showing wick stands of the present invention. FIGS. 2a and 2b are perspective views showing a first embodiment of the wick stand of the present invention. FIG. 3a is an exploded perspective view of the wick stand, and FIG. 3b is a sectional view taken along line A-A′ of FIG. 3a. FIG. 4a is a perspective view showing a second embodiment of the wick stand of the present invention, and FIG. 4b is a sectional view taken along line B-B′ of FIG. 4a.

As shown in FIGS. 3a and 3b, according to the first embodiment of the wick stand of the present invention, the wick stand disposed in a container with paraffin oil accommodated therein comprises a wick fixing portion 10 having a hanging projection 11 at one side thereof and with a wick 1 inserted thereinto and fixed thereto; and a body 20 having an inserting bore 21, into which the wick fixing portion 10 can be inserted, at an upper end thereof which the hanging projection 11 hangs on and is fixed to, and inlet holes 22 for causing the paraffin oil to flow into a lower inner portion of the body.

Further, since an expanded portion 23 having an enlarged diameter is formed below the inserting bore 21 so that the wick can be in contact with a large amount of paraffin oil, the wick can easily absorb the paraffin oil. As the wick, cotton fiber yarn or the like may be used. Preferably, the wick is made of glass fiber, so that semipermanent use of the wick can be obtained by preventing the wick from being worn down and damaged, and the generation of soot and smell can be avoided.

As for the wick fixing portion 10, since it is exposed closely to a flame, it may be made of heat-resistant material such as heat resisting glass to avoid thermal damage thereto.

According to the second embodiment of the wick stand of the present invention shown in FIGS. 4a and 4b, the wick stand disposed in a container with paraffin oil accommodated therein comprises a wick fixing portion 31 with the wick 1 inserted thereinto and fixed thereto, and a supporting portion 32 extending from a lower portion of the wick fixing portion 31 and having inlet holes 33 for causing the paraffin oil to flow into an inner portion of the supporting portion. This wick stand is integrally formed contrary to that of the first embodiment.

With the wick stands of the present invention constructed as such, a lamp can be constructed by supplying a saucer in the form of dish or a container available everywhere in the surroundings with a predetermined amount of paraffin oil and by placing the wick stand of the present invention in the saucer or container, without requiring a separate exclusive container for accommodating the paraffin oil in the conventional lamp, as shown in FIGS. 2a and 2b. Furthermore, upon replenishment of the paraffin oil, it is possible to replenish the saucer or container with the paraffin oil without removing the wick fixing portion from the container.

The wick stand of the present invention described above comprises the wick fixing portion having the hanging projection at one side thereof and with the wick inserted thereinto and fixed thereto; and the body having the inserting bore, into which the wick fixing portion can be inserted, at the upper end thereof which the hanging projection hangs on and is fixed to, and the inlet holes for causing the paraffin oil to flow into the lower inner portion of the body. In this way, since a lamp can be constructed by using a container for accommodating oil, such as an aesthetic cup, teacup or glass available everywhere in the surroundings, without requiring the exclusive container for fixing the wick in the conventional oil lamp, the advantages of convenience of use and low production costs are obtained.

What is claimed is:

1. A wick stand disposed in a container with paraffin oil accommodated therein, comprising:
a wick fixing portion having a hanging projection at one side thereof and with a wick inserted thereinto and fixed thereto; and
a body having an inserting bore, into which said wick fixing portion can be inserted, at an upper end thereof which said hanging projection hangs on and is fixed to, and inlet holes for causing said paraffin oil to flow into a lower inner portion of said body.

2. The wick stand as claimed in claim 1, wherein an expanded portion having an enlarged diameter is formed below said inserting bore so that said wick can easily absorb said paraffin oil.

3. A wick stand disposed in a container with paraffin oil accommodated therein comprising:
a wick fixing portion with the wick inserted thereinto and fixed thereto; and
a supporting portion extending from a lower portion of said wick fixing portion and having inlet holes for causing said paraffin oil to flow into an inner portion of said supporting portion.
